(19) United States
(12) Patent Application Publication
(10) Pub. No.: US 2019/0251404 A1
(43) Pub. Date: Aug. 15, 2019

(54) CHARACTER RECOGNITION DEVICE AND CHARACTER RECOGNITION METHOD

(71) Applicant: SHARP KABUSHIKI KAISHA, Sakai City (JP)

(72) Inventor: TOHRU NAKANISHI, Sakai City (JP)

(21) Appl. No.: 16/274,225

(22) Filed: Feb. 12, 2019

(30) Foreign Application Priority Data
Feb. 13, 2018 (JP) 2018-023452

(51) Int. Cl. G06K 9/72

(52) U.S. Cl. CPC G06K 9/72; G06K 2209/01

(57) ABSTRACT

A character recognition device includes an acquisition unit that acquires two-dimensional page data including a plurality of points which have values corresponding to ink or background and are arranged in a plane; a first recognition unit that recognizes a first character by scanning a first point group among the plurality of points; a candidate character estimation unit that estimates a next candidate character following the first character with reference to the first character recognized by the first recognition unit; and a second recognition unit that recognizes a second character based on the candidate character.

### BACKGROUND

### 1. Field

The present disclosure relates to an apparatus for recognizing characters by scanning two-dimensional page data.

### 2. Description of the Related Art

When opening a book to read, books may be hurt. In particular, old books may be torn or damaged if opened. For example, there are scroll-like old documents discovered in Italy, burned down by an eruption in ancient Roman times. These old documents are difficult to read with naked eyes because it is dark as a whole and it is too fragile to be opened. Here, by performing X-ray phase contrast tomography on such a book, three-dimensional data of the book is acquired without damaging the book.

Further, as an apparatus for generating two-dimensional data corresponding to each page of a book from the above three-dimensional data. International Publication No. 2017/131184 (published in Aug. 3, 2017) discloses a book electronic digitalizing apparatus. The book electronic digitizing apparatus generates two-dimensional page data including a character string or figure (before recognition) described in the book by specifying a page area corresponding to a page of the book using three-dimensional data of the book, and mapping the character string or figure (before recognition) in the page area in a two-dimensional plane. The character string or figure here means a plurality of points before recognition, and a character string or figure is recognized from the plurality of points.

As a next step of generating the two-dimensional page data by the above-mentioned book electronic digitalizing apparatus, there is a step of recognizing a character string or figure described in the book. In this step, a character or figure is recognized by scanning a plurality of points (NODE) having a value (for example, intensity of reflected light of X-ray) corresponding to ink, included in two-dimensional page data.

In the above character recognition step, the two-dimensional page data also includes points having values corresponding to the background besides ink, and thus there is a need for scanning a plurality of points including points corresponding to those backgrounds, and it takes a long time to recognize characters.

It is desirable to efficiently recognize character data from two-dimensional page data.

### SUMMARY

According to one aspect of the present disclosure, there is provided a character recognition device including an acquisition unit that acquires two-dimensional page data including a plurality of points which have values corresponding to ink or background and are arranged in a plane; a first recognition unit that recognizes a first, character by scanning a first point group among the plurality of points; a candidate character estimation unit that estimates a next candidate character following the first character with reference to the first character recognized by the first recognition unit; and a second recognition unit that recognizes a second character based on the candidate character.

According to another aspect of the present disclosure, there is provided a character recognition method including acquiring two-dimensional page data including a plurality of points which have values corresponding to ink or background and are arranged in a plane; first recognizing a first character by scanning a first point group among the plurality of points; estimating a next candidate character following the first character with reference to the first character recognized in the first recognizing; and second recognizing a second character based on the candidate character.

### BRIEF DESCRIPTION OF THE DRAWINGS

FIG. 1 is a block diagram illustrating a configuration of a character recognition system including a character recognition device according to a first embodiment of the present disclosure;

FIG. 2 is a flowchart illustrating a character recognition method with a character recognition device according to the first embodiment of the present disclosure;

FIGS. 3A to 3C are conceptual diagrams illustrating an example of initial setting by a user using the character recognition device according to the first embodiment of the present disclosure;

FIG. 4 is a diagram illustrating an example of a candidate table referred to by a character recognition device according to the first embodiment of the present disclosure;

FIG. 5 is a diagram illustrating an example of two-dimensional page data scanned by the character recognition device according to the first embodiment of the present disclosure;

FIG. 6 is a block diagram illustrating a configuration of a character recognition system including a character recognition device according to a second embodiment of the present disclosure; and

FIG. 7 is a flowchart illustrating a character recognition method with a character recognition device according to the second embodiment of the present disclosure.

### DESCRIPTION OF THE EMBODIMENTS

Hereinafter, embodiments of the present disclosure will be described in detail. However, a configuration described in this embodiment is not limited to only the scope of the present disclosure unless otherwise specified, but is merely an explanatory example.

### First Embodiment

### Character Recognition Device 2

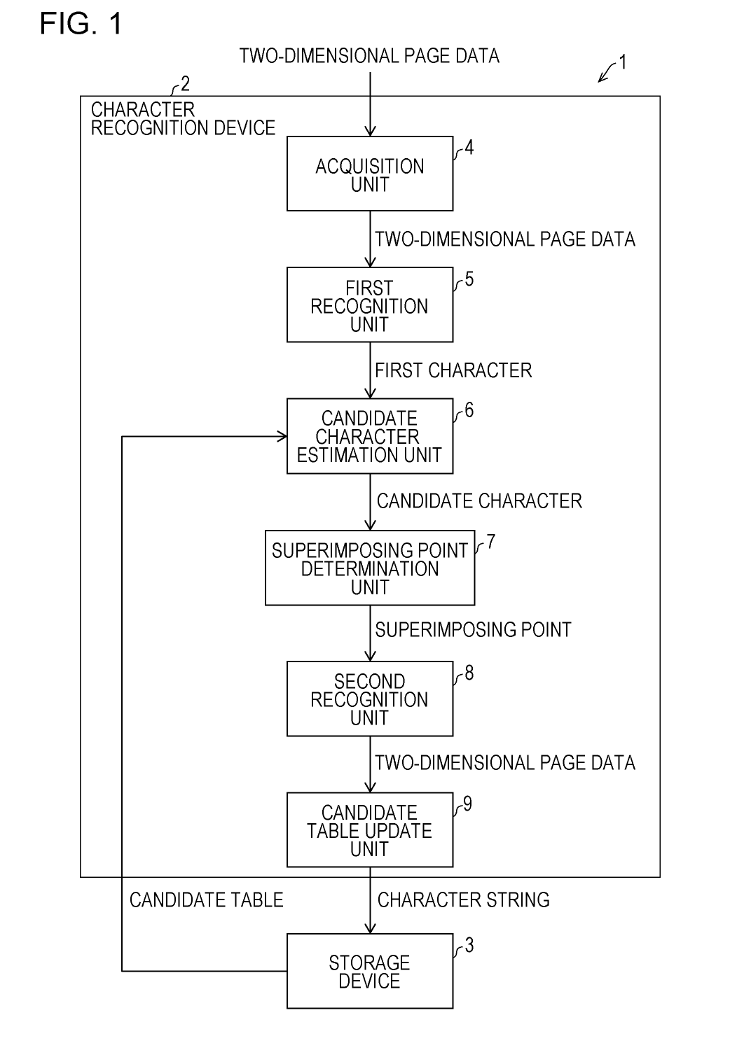

Hereinafter, a character recognition device 2 according to a first embodiment of the present disclosure will be described with reference to FIG. 1. FIG. 1 is a block diagram illustrating a configuration of a character recognition system 1 including a character recognition device 2 according to a first embodiment of the present disclosure. As illustrated in FIG. 1, the character recognition system 1 includes a character recognition device 2 and a storage device 3. In addition, the character recognition device 2 is provided with an acquisition unit 4, a first recognition unit 5, a candidate character estimation unit 6, a superimposing point determination unit 7, a second recognition unit 8, and a candidate table update unit 9.

The acquisition unit 4 acquires two-dimensional page data including a plurality of points (NODE) which have values corresponding to ink or background and are arranged in a plane.

The first recognition unit 5 recognizes a first character by scanning a first point group among the plurality of points included in the two-dimensional page data acquired by the acquisition unit 4.

The candidate character estimation unit 6 estimates the next candidate character following the first character with reference to the first character recognized by the first recognition unit 5. More specifically, the candidate character estimation unit 6 acquires one of a plurality of character strings with reference to the candidate table stored in the storage device 3, and then estimates a character following the first character in the acquired character string as a candidate character. Note that, the candidate table herein may be a table in which the plurality of character strings including the first character are stored.

The superimposing point determination unit 7 determines any one superimposed on the candidate character, among the plurality of points included in the two-dimensional page data, as a superimposing point by disposing the candidate character estimated by the candidate character estimation unit 6 to be adjacent to the first character in the two-dimensional page data.

The second recognition unit 8 recognizes a second character by scanning a second point group among the plurality of points included in the two-dimensional page data with the superimposing point as a starting point, determined by the superimposing point determination unit 8.

The candidate table update unit 9 updates the candidate table stored in the storage device 3 based on the character string including the first character recognized by the first recognition unit 5 and the second character recognized by the second recognition unit 8.

The storage device 3 stores a table in which the plurality of character strings including the first character are stored. Note that, the storage device 3 in this embodiment is installed on the outside of the character recognition device 2, and the same configuration as that of the storage device 3 may be installed in the inside of the character recognition device 2. In addition, the same configuration as that of the storage device 3 is installed in a server, and may be connected to the character recognition device 2 via the Internet.

### Character Recognition Method

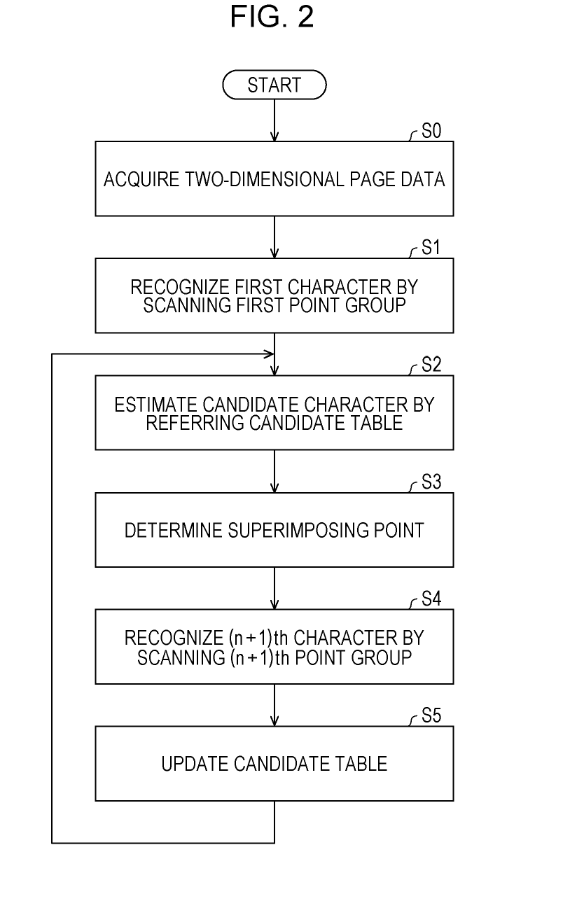

A character recognition method using the character recognition device 2 according to this embodiment will be described with reference to FIG. 2. FIG. 2 is a flowchart illustrating a character 2 recognition method with a character recognition device according to this embodiment.

The acquisition unit 4 acquires two-dimensional page data including a plurality of points which have values corresponding to ink or background and are arranged in a plane (step S0). Incidentally, examples of the “values corresponding to ink or background” here include the intensity of reflected light acquired by X-ray phase contrast tomography and pixel values indicating the intensity. Further, examples of the “two-dimensional page data” acquired by acquisition unit A include two-dimensional page data generated from three-dimensional data by the above-described book electronic digitizing apparatus, and scan data acquired by scanning a book or the like.

Next, the first recognition unit 5 recognizes a first character by scanning a first point group among the plurality of points included in the two-dimensional page data acquired by the acquisition unit 4 (step S1). Note that, the first point group scanned with the first recognition unit 5 means a group consisting of a plurality of points having values corresponding to ink, which is included in the two-dimensional page data. In addition, the first recognition unit 5 recognizes the first character and may also recognize a size of the first character or a space surrounding the first character. For example, in a case where the first recognition unit 5 recognizes a space in an upper portion of the first character, the first character may be recognized as a small character. Further, the first recognition unit 5 preferably stops scanning the first point group at the time when the first character is recognized. Thus, it is possible to shorten the time for performing the step.

Next, the candidate character estimation unit 6 acquires one of a plurality of character strings with reference to the candidate table, in which the plurality of character strings including the first character are stored, stored in the storage device 3, and then estimates a character following the first character in the acquired character string as a candidate character (step S2). Specific examples of the candidate table referred to by the candidate character estimation unit 6 will be described later.

Next, the superimposing point determination unit 1 determines any one superimposed on the candidate character, among the plurality of points included in the two-dimensional page data, as a superimposing point by disposing the candidate character estimated by the candidate character estimation unit 6 to be adjacent to the first character in the two-dimensional page data (step S3). Note that, the superimposing point determination unit 7 may estimate the size of the first character recognized by the first recognition unit 5 or the size of the candidate character with reference to the space surrounding the first character, or the like. With this, the superimposing point is easily determined by disposing the candidate character based on the size to be adjacent to the first character.

The second recognition unit 8 recognizes a second character by scanning a second point group among the plurality of points included in the two-dimensional page data with the superimposing point as a starting point, determined by the superimposing point determination unit 7 (step S4). Note that, similar to the above-described first point group, the second point group scanned with the second recognition unit 8 means a group consisting of a plurality of points having values corresponding to ink, which is included in the two-dimensional page data. In addition, the second recognition unit 8 recognizes the second character and may also recognize a size of the second character or a space surrounding the second character.

Next, the candidate table update unit 9 updates the candidate table stored in the storage device 3 based on the character string including the first character recognized by the first recognition unit 5 and the second character recognized by the second recognition unit 8 (step S5). For example, in a case where the candidate character estimated by the candidate character estimation unit 6 is different from the second character recognized by the second recognition unit 8, the candidate table update unit 9 may lower a candidate priority order of the character string including the first character and the second character in the candidate table. In another example, in a case where the candidate character estimated by the candidate character estimation unit 6 is the same as the second character recognized by the second recognition unit 8, the candidate table update unit 9 may raise a candidate priority order of the character string including the first character and the second character in the candidate table.

In another example, in a case where the character string including the first character recognized by the first recognition unit 5 and the second character recognized by the second recognition unit 8 is not included in the candidate table, the candidate table update unit 9 may add the character string to the candidate table. In addition, the candidate table update unit 9 may store the size of the first character recognized by the first recognition unit 5, the space surrounding the first character, the size of the second character recognized by the second recognition unit S, or the space surrounding the second character to the storage device 3 as information attached to the candidate table.

In addition, the above-described steps S2 to S5 are repeatedly performed for recognizing the character other than the first character and the second character included in the character string. More specifically, after first step S5 is completed, in step S2, the candidate character estimation unit 6 acquires any one of the plurality of character strings with reference to the updated candidate table, in which the plurality of character strings including the first character and the second character are stored, and then estimates a character following the second character in the acquired character string as a candidate character. Note that, in a case where the number of trials of step S2 is the third or later, the candidate character estimation unit 6 estimates the candidate character with reference to the updated candidate table in which the character string including the character recognized so far is stored.

Next, in step S3, the superimposing point determination unit 7 determines any one superimposed on the candidate character, among the plurality of points included in the two-dimensional page data, as a superimposing point by disposing the candidate character estimated by the candidate character estimation unit 6 to be adjacent (position opposite to the first character) to the second character in the two-dimensional page data. Note that, in a case where the number of trials of step S3 is the third or later, when the number of trials of step S3 is n times, the superimposing point determination unit 7 arranges the candidate characters adjacent to the n-th character so as to determine the superimposing point.

In step S3, the superimposing point determination unit 7 may estimate the size of the candidate character based on the size of the first character, the space surrounding the first character, the size of the second character, or the space surrounding the second character which are stored in the storage device 3 in step S5. With this, the superimposing point is easily determined by disposing the candidate character based on the size to be adjacent to the third character. Further, the superimposing point determination unit 7 may calculate an average value of the sizes of characters (first letters and the like) stored in the storage device 3 and estimate the size of the candidate character based on the average value.

Next, in step S4, the second recognition unit 8 recognizes a third character by scanning the third point group among the plurality of points included in the two-dimensional page data with the superimposing point as a starting point, determined by the superimposing point determination unit 7 (“n” in step S4 illustrated in FIG. 2 indicates the number of trials in step S4). Mote that, in a case where the number of trials of step S4 is the third or later, the second recognition unit 8 recognizes (n+1) th character by scanning (n+1) th point group with the superimposing point as a starting point.

Next, in step S5, the candidate table update unit 9 updates the candidate table stored in the storage device 3 based on the character string including the first character recognized by the first recognition unit 5, the second character, and the third character recognized by the second recognition unit 8. Note that, in a case where the number of trials of step S5 is the third or later, the candidate table update unit 9 updates the candidate table based on the character string including the character recognized so far.

As described above, the character recognition device 2 according to this embodiment can recognize characters subsequent to the third character indicated by a plurality of points included in two-dimensional page data by repeatedly performing steps S2 to S5.

Note that, in step S3, in a case where the superimposing point determination unit 7 is not able to detect the point superimposing on the candidate character in the two-dimensional page data, the process returns to step S1, and the first recognition unit 5 may newly recognize the first character by scanning any point group included in the two-dimensional page data. Alternatively, in a case where the character recognized by the second recognition unit 8 in step S4 is the same as the final character of the character string acquired by the candidate character estimation unit 6 in step S2, the process returns to step S1, and the first recognition unit 5 may newly recognize the first character by scanning another point group included in the two-dimensional page data.

### EXAMPLES

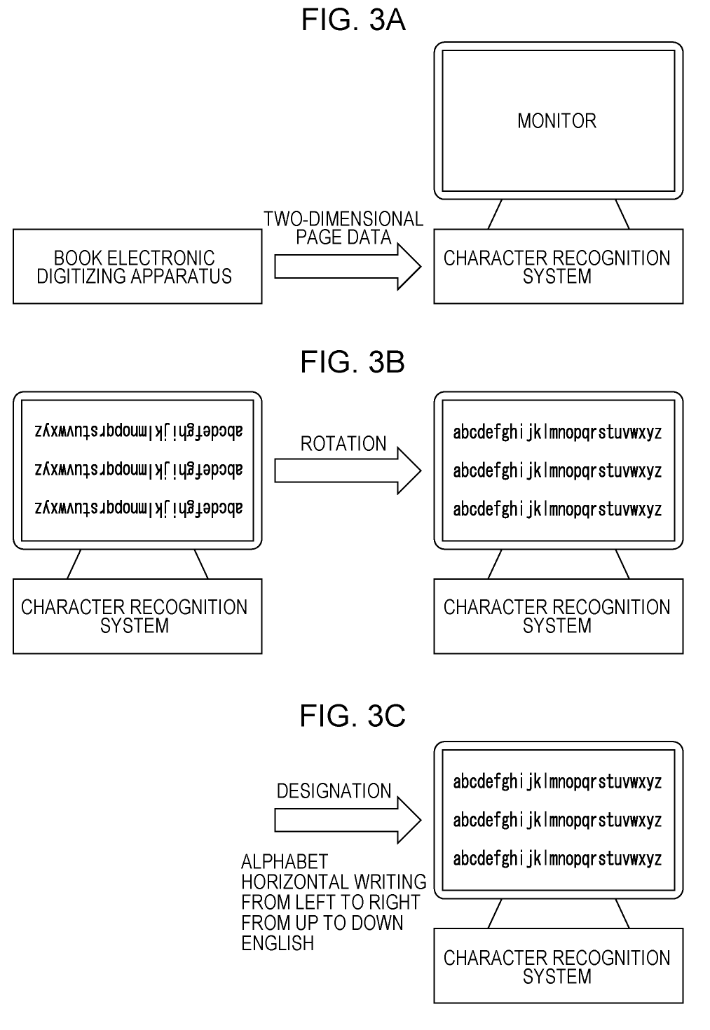

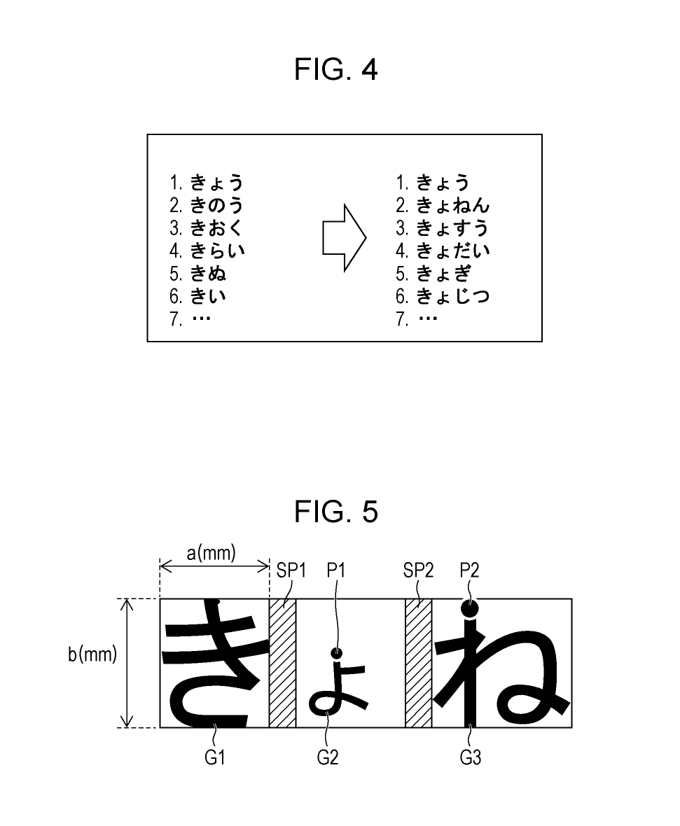

Hereinafter, examples of the character recognition method according to this embodiment will be described below with reference to FIGS. 3 to 5. FIG. 3A to 3C are conceptual diagrams illustrating an example of initial setting by a user using the character recognition device 2 according to this embodiment. FIG. 4 is a diagram illustrating an example of a candidate table referred to by the candidate character estimation unit 6 in the above-described step S2. FIG. 5 is a diagram illustrating an example of two-dimensional page data scanned by the character recognition device 2.

As described in FIG. 3A, the character recognition system 1 according to this example is connected to a monitor. Although not shown, the character recognition system 1 according to this example is connected to the Internet, and can acquire or update the aforementioned candidate table stored in the external storage device 3. Note that, the character recognition system 1 having such a configuration can be constructed with a personal computer as long as it has sufficient processing capability.

Hereinafter, the character recognition method performed by the character recognition system 1 according to this example will be described. First, in the above step 50, the acquisition unit 4 acquires two-dimensional page data from the book electronic digitizing apparatus as illustrated in FIG. 3A.

Next, before performing the above-described step 51, as illustrated in FIG. 3A, the character recognition system 1 selects one page out of the two-dimensional page data acquired by the acquisition unit 4 and displays the page on the monitor. In a case where there are fewer characters in the page, it is difficult to perform post process, so that the two-dimensional page data to be processed in step S1 and subsequent steps may be a page containing about 30% of character data for the area of one page.

Next, a user confirms a character data screen of the page displayed on the monitor, and as illustrated in FIG. 3B, rotates the screen by using an input device (not shown) such as a keyboard and the like such that the characters are arranged in a correct readable direction with respect to the user.

Thereafter, as illustrated in FIG. 3C, using the input device, the user designates information such as directions in which the characters are arranged (horizontal writing, vertical writing, reading from the left, reading from the right, and the like), kinds of characters (Alphabet, Arabic character, Chinese character, and the like), or languages (English, French, Japanese, and the like) to the character recognition system 1. With this, the character recognition system 1 can confirm a first point group corresponding to the first character to start recognition, a recognition direction, and a recognition method.

Next, in the above-described step S1, the first recognition unit 5 scans the first point group G1, recognizes the first character by pattern recognition or the like, and then recognizes the character and the size of the character. Hereinafter, the first recognition unit 5 recognizes “ [symbol] (ki)” as the first character and sets a horizontal size a (mm) and a vertical size b (mm) beside “ [symbol] ” as the size of the first character, (refer to the first point group G1 of the two-dimensional page data illustrated in FIG. 5).

Next, in the above-described step S2, the candidate character estimation unit 6 acquires one of the plurality of character strings, and then estimates a character following the first character “ [symbol] ” in the acquired character string as a candidate character with reference to the candidate table stored in the storage device 3 or the candidate table stored in the database in the external system connected via the Internet.

Hereinafter, step S2 will be more specifically described with reference to the candidate table as illustrated in FIG. 4. In the candidate table referred to by the candidate character estimation unit 6 in step S2, as candidate table A illustrated in FIG. 4, there are a plurality of character string candidates in which “ [symbol] ” is a head character. In addition, these character string candidates have a priority order as a candidate (numbers attached to the character string in FIG. 4). The candidate character estimation unit 6 acquires “ [symbol] (kyou)” of the first priority order included in the candidate table A and estimates the character “ [symbol] (yo)” following the first character “ [symbol] ” in the character stings, as a candidate character.

In step S3 as the subsequent step of step S2, the superimposing point determination unit 1 determines any one superimposed on the candidate character, among the plurality of points included in the two-dimensional page data, as a superimposing point by disposing the candidate character “ [symbol] ” estimated by the candidate character estimation unit 6 to be adjacent the first character “ [symbol] ” to the second character in the two-dimensional page data (in the two-dimensional page data as illustrated in FIG. 5, point P1 is a superimposing point (it has been expanded to emphasize in the drawings)). The superimposing point determination unit 7 may determine the size of the candidate character “ [symbol] ” disposed in the two-dimensional page data corresponding to the horizontal size a (mm) and the vertical size b (mm) of the first character recognized by the first recognition unit.

Next, in step S4, the second recognition unit 8 recognizes a second character “ [symbol] ” by scanning the second point group G2 among the plurality of points included in the two-dimensional page data with the superimposing point P1, as a starting point, determined by the superimposing point determination unit 7.

Next, in step S5, the candidate table update unit 9 updates the candidate table stored in the storage device 3 based on the character string including the first character “ [symbol] ” recognized by the first recognition unit 5, the second character “ [symbol] ” recognized by the second recognition unit 8. More specifically, as illustrated in FIG. 4, the candidate table update unit 9 raises the priority order of the character string including the first character “ [symbol] ” and the second character “ [symbol] ” in the candidate table A so as to update the candidate table A to the candidate table B (the priority is raised for “ [symbol] (Kyonen)”, “ [symbol] (Kyosu)”, “ [symbol] (Kyodai)”, “ [symbol] (Kyogi)”, and “ [symbol] (Kyozitsu”).

Next, returning to step S2, the candidate character estimation unit 6 acquires the character string “ [symbol] ” in the first priority order included in the candidate table B, and then estimates the character “ [symbol] (u)” following the second character “ [symbol] ” in the acquired character string as a candidate character with reference to updated candidate table B stored in the plurality of character strings including the first character “ [symbol] ” and the second character “ [symbol] ”. Since the character string “ [symbol] ” is the same as the character string acquired in step S2 that was executed last time, the candidate character estimation unit does not refer to the update table, and estimates the character “ [symbol] ” following the second character in the previously acquired character string as a candidate character.

Next, in step S3, the superimposing point determination unit 7 determines any one superimposed on the candidate character, among the plurality of points included in the two-dimensional page data, as a superimposing point P2 by disposing the candidate character “ [symbol] ” is not shown in FIG. 5) estimated by the candidate character estimation unit 6 to be adjacent the second character “ [symbol] ” to the second character in the two-dimensional page data (in FIG. 5, the superimposing point P2 has been expanded to emphasize in the drawings).

Next, in step S4, the second recognition unit 8 recognizes a third character “ [symbol] (ne)” which is different from the candidate character “ [symbol] ” by scanning the third point group G3 among the plurality of points included in the two-dimensional page data with the superimposing point P2, as a starting point, determined by the superimposing point determination unit 7.

Next, in step S5, the candidate table update unit 9 updates the candidate table stored in the storage device 3 based on the character string including the first character “ [symbol] ” recognized by the first recognition unit 5, the second character “ [symbol] ” and the third character “ [symbol] ” recognized by the second recognition unit 8. More specifically, the candidate table update unit 9 raises the priority order of the character string “ [symbol] ” including the first character “ [symbol] ”, the second character “ [symbol] ”, and the third character “ [symbol] ” the candidate table B up to the first so as to update the candidate table B to the candidate table C (not shown).

Again, returning to step S2, the candidate character estimation unit 6 acquires the character string “ [symbol] ” in the first priority order included in the candidate table C, and then estimates the character “ [symbol] (in) ” following the third character “ [symbol] ” in the acquired character string as a candidate character with reference to updated candidate table C stored in the plurality of character strings including the first character “ [symbol] ”, the second character “ [symbol] ”, and the third character “ [symbol] ”.

Next, in step S3, the superimposing point determination unit 7 determines any one superimposed on the candidate character, among the plurality of points included in the two-dimensional page data, as a superimposing point P3 (not shown) by disposing the candidate character “ [symbol] ” estimated by the candidate character estimation unit 6 to be adjacent to the third character “ [symbol] ” in the two-dimensional page data.

Next, in step S4, the second recognition unit 3 recognizes a fourth character “ [symbol] ” by scanning the fourth point group G4 (not shown) among the plurality of points included in the two-dimensional page data with the superimposing point P3, as a starting point, determined by the superimposing point determination unit 7. Note that, since the character “ [symbol] ” recognized by the second recognition unit 8 in step S4 is the same as the final character of the character string “ [symbol] ” acquired by the candidate character estimation unit 6 in step S2, the process returns to step S1, and the first recognition unit 5 may newly recognize the first character by scanning another point group included in the two-dimensional page data.

### Summary of First Embodiment

As described above, the character recognition device 2 according to this embodiment is provided with an acquisition unit that acquires two-dimensional page data including a plurality of points which have values corresponding to ink or background and are arranged in a plane; a first recognition unit 5 that recognizes a first character by scanning a first point group among the plurality of points; a candidate character estimation unit 6 that estimates a next candidate character following the first character with reference to the first character recognized by the first recognition unit 5; and a second recognition unit 8 that recognizes a second character based on the candidate character.

According to the above configuration, since the character corresponding to the second character can be estimated in advance as a candidate character, it is easier to recognize the second character based on the candidate character. With this, it is possible to efficiently recognize character data from two-dimensional page data.

More specifically, the character recognition device 2 according to this embodiment further includes a superimposing point determination unit 7 that determines any one, among the plurality of points, superimposed on the candidate character in a case where the candidate character is disposed adjacent to the first character in the two-dimensional page data as a superimposing point, in which the second recognition unit 8 recognizes the second character by scanning the second point group among the plurality of points with the superimposing point as a starting point.

According to the above configuration, since scanning is performed from the superimposing point, scanning of the space between the first character and the second character is not repeated. With this, it is possible to efficiently recognize character data from two-dimensional page data.

### Second Embodiment

A second embodiment of the present disclosure will be described below with reference to the drawings. For convenience of explanation, members having the same functions as the members described in the first embodiment are denoted by the same reference numerals, and description thereof will not be repeated.

### Character Recognition Device 101

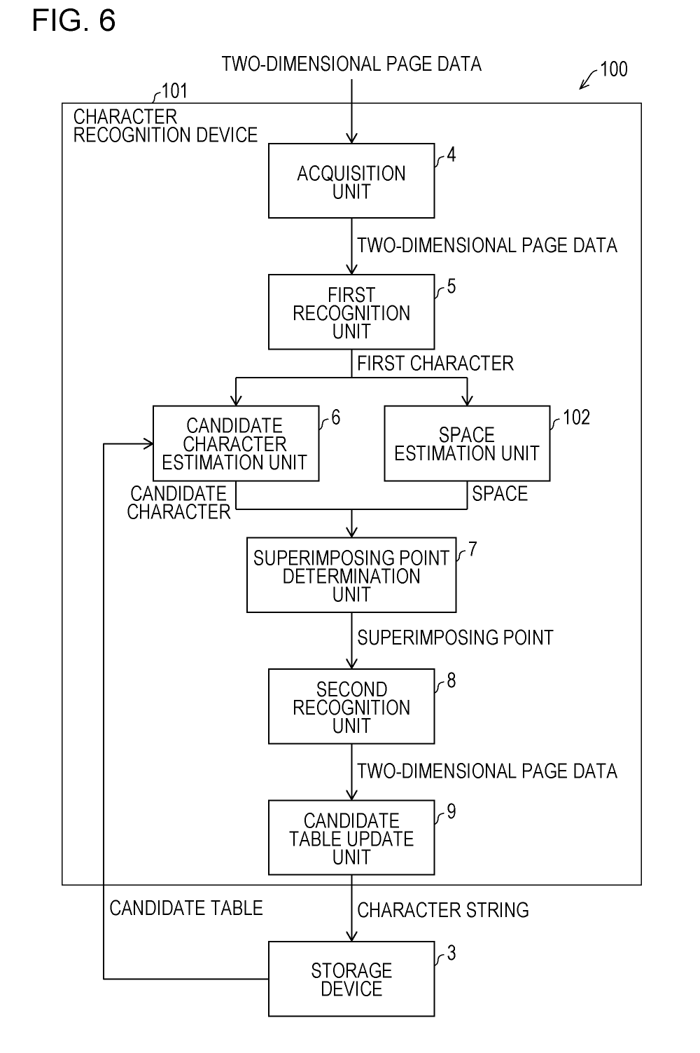

Hereinafter, a character recognition device 101 according to the second embodiment of the present disclosure will be described with reference to FIG. 6. FIG. 6 is a block diagram illustrating a configuration of a character recognition system 100 including a character recognition device 101 according to the second embodiment of the present disclosure. As illustrated in FIG. 6, the character recognition device 101 further includes a space estimation unit 102.

The space estimation unit 102 estimates the space disposed adjacent to the first character in the two-dimensional page data with reference to the first character recognized by the first recognition unit 5.

### Character Recognition Method

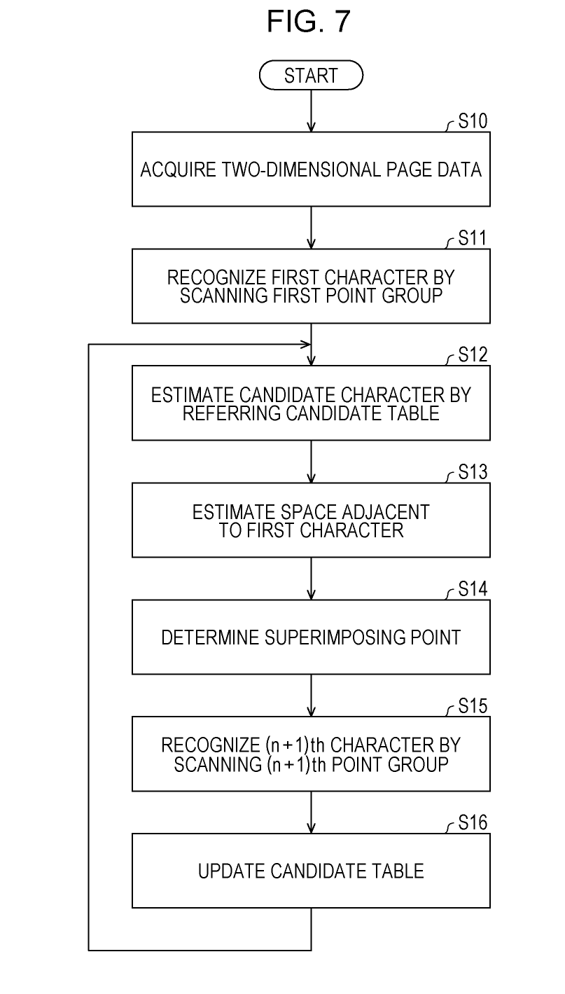

A character recognition method using the character recognition device 101 according to this embodiment will be described with reference to FIG. 7. FIG. 7 is a flowchart illustrating a character recognition method with a character recognition device 101 according to this embodiment. Note that, the character recognition method using the character recognition device 101 according to this embodiment is the same as the character recognition method according to the first embodiment except that a new step is added next to step S2, some of the processes in step S3 are different, and some of the processes in step S5 are different. Thus, the same steps of the character recognition method according to the first embodiment will not be specifically described below.

The acquisition unit 4 acquires two-dimensional page data including a plurality of points which have values corresponding to ink or background and are arranged in a plane (step S10).

Next, the first recognition unit 5 recognizes a first character by scanning a first point group among the plurality of points included in the two-dimensional page data acquired by the acquisition unit 4 (step S11).

Next, the candidate character estimation unit 6 acquires one of a plurality of character strings with reference to the candidate table, in which the plurality of character strings including the first character are stored, stored in the storage device 3, and then estimates a character following the first character in the acquired character string as a candidate character (step S12).

Next, the space estimation unit 102 estimates the space disposed adjacent to the first character in the two-dimensional page data with reference to the first character recognized by the first recognition unit 5 (step S13).

In addition, in step S13, the space estimation unit 102 may estimate the space disposed adjacent to the first character in the two-dimensional page data with reference to the first character and the size of the first character. Specifically, when step S13 is described in detail with reference to FIG. 5 used in the first embodiment, for example, the space estimation unit 102 estimates the space SP 1 disposed adjacent to the first character “ [symbol] ” in the two-dimensional page data with the first character with reference to the first character “ [symbol] ” recognized by the first recognition unit 5 and the horizontal size a and the vertical size b of “ [symbol] ”.

As a step subsequent to step S13, the superimposing point determination unit 7 arranges candidate characters estimated by the candidate character estimation unit 6 adjacent to the first character in the two-dimensional page data, superimposes the candidate characters, and determines any point within the area disposed adjacent to the first character with the space estimated by the space estimation unit 102 interposed therebetween as a point (superimposing point) to be superimposed on the candidate character (step S14),

When step S14 is specifically described with reference to FIG. 5 used in the first embodiment, for example, the superimposing point determination unit 7 determines a point P1 within the area disposed adjacent to the first character “ [symbol] ” with the space SP1 estimated by the space estimation unit 102 interposed therebetween as a point to be superimposed on the candidate character.

The second recognition unit 8 recognizes a second character by scanning a second point group among the plurality of points included in the two-dimensional page data with the superimposing point as a starting point, determined by the superimposing point determination unit 7 (step S15). Further, the second recognition unit 8 may recognize the space between the first character and the second character based on the position of the recognized second character.

Next, the candidate table update unit 9 updates the candidate table stored in the storage device 3 based on the character string including the first character recognized by the first recognition unit 5 and the second character recognized by the second recognition unit 8 (step S16).

In step S16, the candidate table update unit 9 may store the space between the first character and the second character recognized by the second recognition unit 8 in the storage device 3 as information attached to the candidate table.

In addition, similar to the first embodiment, the above-described steps S12 to S16 are repeatedly performed for recognizing the character other than the first character and the second character included in the character string.

When describing only a step which is different from that in first embodiment, in the second step S13, the space estimation unit 102 estimates the space disposed adjacent to the second character in the two-dimensional page data with reference to the first character recognized by the first recognition unit 5 and the second character recognized by the second recognition unit 8.

Further, the space estimation unit 102 may estimate the space disposed adjacent to the second character in the two-dimensional page data with reference to the space between the first character and the second character stored in the storage device 3. Note that, in a case where the number of trials of step S13 is the third or later, when the number of trials of step S13 is set as n-th, the space estimation unit 102 estimates the space disposed adjacent to the n-th character in the two-dimensional page data with reference to at least the n-th character recognized by the second recognition unit 8.

In addition, in the second step S14, the superimposing point determination unit 7 arranges candidate characters estimated by the candidate character estimation unit 6 adjacent to the second character in the two-dimensional page data, superimposes the candidate characters, and determines any point within the area disposed adjacent to the second character with the space estimated by the space estimation unit 102 interposed therebetween as a point (superimposing point) to be superimposed on the candidate character.

Note that, in a case where the number of trials of step S14 is the third or later, when the number of trials of step S14 is set as n-th, the superimposing point determination unit 7 arranges candidate characters estimated by the candidate character estimation unit 6 adjacent to the n-th character in the two-dimensional page data, superimposes the candidate characters, and determines any point within the area disposed adjacent to the n-th character with the space estimated by the space estimation unit 102 interposed therebetween as a point (superimposing point) to be superimposed on the candidate character.

### Summary of Second Embodiment

As described above, the character recognition device 101 according to this embodiment further includes a space estimation unit 102 that estimates a space to be disposed adjacent to the first character in the two-dimensional page data, in which the superimposing point determination unit 7 determines any point within the area disposed adjacent to the first character with the space interposed therebetween as a point to be superimposed on the candidate character.

According to the above configuration, since the position of the superimposing point is limited to be within the area disposed adjacent to the first character with the estimated space interposed therebetween, the position of the superimposing point can be easily determined. With this, it is possible to efficiently recognize character data from two-dimensional page data.

### Implementation Example Using Software

A control blocks of character recognition devices 2 and 101 (in particular, the candidate character estimation unit 6, the superimposing point determination unit 7, and the second recognition unit 8) may be implemented by a logic circuit (hardware) formed in an integrated circuit (IC chip), or may be implemented by software.

In the latter case, the character recognition devices 2 and 101 are equipped with a computer for executing instructions of a program which is software for implementing each function. The computer includes, for example, at least one processor (control device) and at least one computer-readable recording medium storing the program. In the computer, a purpose of the present disclosure is achieved by the processor which reads the program from the recording medium and executes the program. As the processor, a central processing unit (CPU) can be used. As the recording medium, “non-temporary tangible medium” such as a read only memory (ROM), and others of a tape, a disk, a card, a semiconductor memory, a programmable logic circuit, and the like can be used. Further, it may further include a random access memory (RAM) and the like that develop the above program. Further, the program may be supplied to the computer via an arbitrary transmission medium (a communication network, a broadcast wave, or the like) capable of transmitting the program. Note that, one aspect of the present disclosure can also be implemented in the form of a data signal embedded in a carrier wave, the program being embodied by electronic transmission.

### Summary

The character recognition device (2, 101) according to the first aspect of the present disclosure is provided with an acquisition unit (4) that acquires two-dimensional page data including a plurality of points which have values corresponding to ink or background and are arranged in a plane; a first recognition unit (5) that recognizes a first character by scanning a first point group among the plurality of points; a candidate character estimation unit (6) that estimates a next candidate character following the first character with reference to the first character recognized by the first recognition unit; and a second recognition unit (8) that recognizes a second character based on the candidate character.

According to the above configuration, since the character corresponding to the second character can be estimated in advance as a candidate character, it becomes easy to recognize the second character based on the candidate character. With this, it is possible to efficiently recognize character data from two-dimensional page data.

In the above first aspect, the character recognition device (2, 101) according to a second aspect of the present disclosure may further include a superimposing point determination unit (7) that determines any one, among the plurality of points, superimposed on the candidate character in a case where the candidate character is disposed adjacent to the first character in the two-dimensional page data as a superimposing point, in which the second recognition unit may recognize the second character by scanning the second point group among the plurality of points with the superimposing point as a starting point.

According to the above configuration, since scanning is performed from the superimposing point, scanning of the space between the first character and the second character is not repeated. With this, it is possible to efficiently recognize character data from two-dimensional page data.

In the second aspect, the character recognition device (101) according to a third aspect of the present disclosure may further include a space estimation unit (102) that estimates a space to be disposed adjacent to the first character in the two-dimensional page data, in which the superimposing point determination unit may determine any point within the area disposed adjacent to the first character with the space interposed therebetween as a point to be superimposed on the candidate character.

According to the above configuration, since the position of the superimposing point is limited to be within the area disposed adjacent to the first character with the estimated space interposed therebetween, the position of the superimposing point can be easily determined. With this, it is possible to efficiently recognize character data from two-dimensional page data.

In the first to third aspects, in the character recognition device (2, 101) according to a fourth aspect of the present disclosure, the candidate character estimation unit may acquire one of a plurality of character strings with reference to the candidate table, in which the plurality of character strings including the first character are stored, stored in the storage device, and then estimate a character following the first character in the acquired character string as a candidate character.

According to the above configuration, the candidate character can be estimated based on the candidate table stored in the plurality of character strings. With this, it is possible to efficiently recognize character data from two-dimensional page data.

In the fourth aspect, the character recognition device (2, 101) according to a fifth aspect of the present disclosure may further include a candidate table update unit that updates the candidate table based on a character string including the first character and the second character.

According to the above configuration, since the candidate table is updated based on the character string including the recognized character, the accuracy of estimating the candidate character with reference to the candidate table is improved. With this, it is possible to efficiently recognize character data from two-dimensional page data.

The character recognition method according to a sixth aspect of the present disclosure includes an acquisition step of acquiring two-dimensional page data including a plurality of points which have values corresponding to ink or background and are arranged in a plane; a first recognition step of recognizing a first character by scanning a first point group among the plurality of points; a candidate character estimation step of estimating a next candidate character following the first character with reference to the first character recognized in the first recognition step; and a second recognition step of recognizing a second character based on the candidate character.

According to the above configuration, the same effect as those in the first aspect is exhibited.

The character recognition device according to each embodiment of the present disclosure may be realized by a computer. In this case, a control program of a character recognition device that causes a computer to realize the character recognition device by allowing a computer to operate as each unit (software element) of the character recognition device, and a computer readable recording medium in which the program is recorded are included in the category of the present disclosure.

The present disclosure is not limited to the above-described embodiments, and various modifications are possible within the scope indicated in the claims, and embodiments obtained by appropriately combining technical means respectively disclosed in different embodiments are also included in the technical scope of the present disclosure. Further, new technical features can be formed by combining technical means disclosed in each embodiment.

The present disclosure contains subject matter related to that disclosed in Japanese Priority Patent Application JP 2018-023452 filed in the Japan Patent Office on Feb. 13, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A character recognition device comprising:
an acquisition unit that acquires two-dimensional page data including a plurality of points which have values corresponding to ink or background and are arranged in a plane;
a first recognition unit that recognizes a first character by scanning a first point group among the plurality of points;
a candidate character estimation unit that estimates a next candidate character following the first character with reference to the first character recognized by the first recognition unit; and
a second recognition unit that recognizes a second character based on the candidate character.

2. The character recognition device according to claim 1, further comprising:
a superimposing point determination unit that determines any one, among the plurality of points, superimposed on the candidate character in a case where the candidate character is disposed adjacent to the first character in the two-dimensional page data, as a superimposing point,. wherein the second recognition unit recognizes the second character by scanning a second point group among the plurality of points with the superimposing point as a starting point.

3. The character recognition device according to claim 2, further comprising:
a space estimation unit that estimates a space to be disposed adjacent to the first character in the two-dimensional page data,
wherein the superimposing point determination unit determines any point within an area disposed adjacent to the first character with the space interposed therebetween as a point to be superimposed on the candidate character.

4. The character recognition device according to claim 1,
wherein the candidate character estimation unit acquires any one of a plurality of character strings with reference to a candidate table, in which the plurality of character strings including the first character are stored, and then estimates a character following the first character in the acquired character string as a candidate character.

5. The character recognition device according to claim 4, further comprising:
a candidate table update unit that updates the candidate table based on a character string including the first character and the second character.

6. A character recognition method comprising:
acquiring two-dimensional page data including a plurality of points which have values corresponding to ink or background and are arranged in a plane;
first recognizing a first character by scanning a first point group among the plurality of points;
estimating a next candidate character following the first character with reference to the first character recognized in the first recognizing; and
second recognizing a second character based on the candidate character.
